(19) United States
(12) Patent Application Publication
(10) Pub. No.: US 2024/0242891 A1
(43) Pub. Date: Jul. 18, 2024

(54) SOLID ELECTROLYTIC CAPACITOR AND METHOD FOR PRODUCING SOLID ELECTROLYTIC CAPACITOR

(71) Applicant: Panasonic Intellectual Property Management Co., Ltd., Osaka (JP)

(72) Inventors: TSUYOSHI KUSAKABE, Fukuoka (JP); MASANORI KASHIHARA, Saga (JP); RIE SHIMOOKA, Osaka (JP); MASAYUKI SATO, Saga (JP)

(21) Appl. No.: 18/290,785

(22) PCT Filed: Jul. 12, 2022
(86) PCT No.: PCT/JP2022/027458

§ 371 Date: Jan. 21, 2024

(30) Foreign Application Priority Data
Jul. 29, 2021 (JP) 2021-124385
Aug. 31, 2021 (JP) 2021-141481
Aug. 31, 2021 (JP) 2021-141482

(51) Int. Cl. H01G 9/012; H01G 9/00; H01G 9/08; H01G 9/15

(52) U.S. Cl. CPC H01G 9/012; H01G 9/0029; H01G 9/08; H01G 9/15

(57) ABSTRACT

A solid electrolytic capacitor includes a capacitor element including an anode part and a cathode part, an anode lead frame electrically connected to the anode part, a cathode lead frame electrically connected to the cathode part, and an exterior body covering the capacitor element. The anode lead frame includes a first buried part that is a part of the anode lead frame and is buried in the exterior body, and the cathode lead frame includes a second buried part that is a part of the cathode lead frame and is buried in the exterior body. A plurality of recesses are formed on a surface of at least one of the first buried part or the second buried part.

### TECHNICAL FIELD

The present disclosure relates to a solid electrolytic capacitor and a method for producing the solid electrolytic capacitor.

### BACKGROUND

Solid electrolytic capacitors are mounted on various electronic devices. A capacitor element, which is a main part of a solid electrolytic capacitor, includes an anode part, a dielectric layer, and a cathode part. The capacitor element deteriorates in characteristics by coming into contact with oxygen and moisture. In particular, the solid electrolyte layers greatly deteriorate due to the influence of oxygen and moisture.

The periphery of the capacitor element is covered with an exterior body including resin. However, even when the capacitor element is covered with the exterior body, oxygen and moisture enter through various paths, and the electrolyte layer deteriorates. Measures for suppressing such deterioration have been conventionally proposed.

PTL 1 (Unexamined Japanese Patent Publication No. H05-021290) discloses “A solid electrolytic capacitor including: an anodic oxidation film formed on a plate or foil made of a valve metal as a dielectric material; a dielectric polymer layer and a dielectric layer sequentially formed on a predetermined portion of the dielectric material to constitute a capacitor element; a lead frame serving as a lead-out terminal connected to a valve metal part and a conductor layer part of the capacitor element; and a mold resin externally covering a part of the capacitor element and the lead frame, wherein a solder alloy layer or a tin metal layer having a copper metal layer as a base is formed on a surface of the lead frame other than a portion in contact with the mold resin, only a copper metal layer is formed on the portion of the lead frame in contact with the mold resin, and a surface of the copper metal layer is roughened”.

PTL 2 (Unexamined Japanese Patent Publication No. 2013-171986) discloses “A solid electrolytic capacitor including: a capacitor element including an anode body in which an anode wire is buried, a dielectric material film provided on a surface of the anode body, and a solid electrolyte provided on a surface of the dielectric material film and containing a conductive polymer; an exterior body covering the capacitor element; an anode lead frame electrically connected to the anode wire, extending from an inside to an outside of the exterior body, and functioning as an anode terminal; and a cathode lead frame electrically connected to the solid electrolyte layer, extending from the inside to the outside of the exterior body, and functioning as a cathode terminal, wherein a solder plating layer is provided on a surface of the cathode lead frame, and the solder plating layer has a divided part in a region including a first boundary part that is a boundary between the inside and the outside of the exterior body on the cathode lead frame side”.

### CITATION LIST

### Patent Literature

PTL 1: Unexamined Japanese Patent Publication No. H05-021290
PTL 2: Unexamined Japanese Patent Publication No. 2013-171986

### SUMMARY

A solid electrolytic capacitor according to a first aspect of the present disclosure includes a capacitor element including an anode part and a cathode part, an anode lead frame electrically connected to the anode part, a cathode lead frame electrically connected to the cathode part, and an exterior body covering the capacitor element. The anode lead frame includes a first buried part that is a part of the anode lead frame and is buried in the exterior body, and the cathode lead frame includes a second buried part that is a part of the cathode lead frame and is buried in the exterior body. A plurality of recesses are formed on a surface of at least one of the first buried part or the second buried part.

A solid electrolytic capacitor according to a second aspect of the present disclosure includes a capacitor element including an anode part and a cathode part, an anode lead frame electrically connected to the anode part, a cathode lead frame electrically connected to the cathode part via a conductive adhesive layer including conductive particles, and an exterior body covering the capacitor element. The anode lead frame includes a first buried part that is a part of the anode lead frame and is buried in the exterior body, and the cathode lead frame includes a second buried part that is a part of the cathode lead frame and is buried in the exterior body. At least one of the first buried part or the second buried part includes a first surface in contact with the exterior body, and the second buried part includes a second surface in contact with the conductive adhesive layer. A plurality of first recesses are formed on the first surface. The exterior body includes a resin and an insulating filler. An average diameter D1 of openings of the plurality of first recesses and an average particle diameter P1 of the insulating filler satisfy 0<P1/D1<1.

A method for producing a solid electrolytic capacitor according to a third aspect of the present disclosure is a method for producing solid electrolytic capacitor. The solid electrolytic capacitor includes a capacitor element including an anode part and a cathode part, an anode lead frame electrically connected to the anode part, and a cathode lead frame electrically connected to the cathode part. The anode lead frame includes a first buried part that is a part of the anode lead frame, and the cathode lead frame includes a second buried part that is a part of the cathode lead frame. The method includes the following steps (i), (ii), and (iii). In step (i), a plurality of recesses are formed on a surface of at least one of the first buried part or the second buried part by irradiating at least one of the first buried part or the second buried part with laser light a plurality of times. In step (ii), the first buried part is electrically connected to the anode part of the capacitor element and the second buried part is electrically connected to the cathode part of the capacitor element. In step (iii), the first buried part, the second buried part, and the capacitor element are covered with an exterior body. The step (i) includes step (i-a) of preparing at least one of the anode lead frame or the cathode lead frame including a base material and a plating layer formed on the base material, and step (i-b) of irradiating the plating layer on at least one of the first buried part or the second buried part with the laser light a plurality of times to form the plurality of recesses while the plating layer remains in a region between the plurality of recesses.

According to the present disclosure, a solid electrolytic capacitor with high reliability is obtained.

### BRIEF DESCRIPTION OF THE DRAWINGS

FIG. 1 is a sectional view schematically illustrating a solid electrolytic capacitor of a first exemplary embodiment.

FIG. 2A is a top view schematically illustrating an example of arrangement of a recess in the first exemplary embodiment.

FIG. 2B is a view schematically illustrating a section taken along line A-A in FIG. 2A.

FIG. 3 is a top view illustrating an example of arrangement of a plurality of recesses.

FIG. 4 is a top view illustrating another example of arrangement of a plurality of recesses.

FIG. 5 is a top view illustrating another example of arrangement of a plurality of recesses.

FIG. 6 is a top view illustrating another example of arrangement of a plurality of recesses.

FIG. 7 is a top view illustrating another example of arrangement of a plurality of recesses.

FIG. 8 is a top view illustrating another example of arrangement of a plurality of recesses.

FIG. 9 is a top view illustrating another example of arrangement of a plurality of recesses.

FIG. 10 is a top view illustrating another example of arrangement of a plurality of recesses.

FIG. 11 is a top view illustrating another example of arrangement of a plurality of recesses.

FIG. 12 is a top view illustrating an example of a buried part of a lead frame.

FIG. 13A is a top view schematically illustrating an example of arrangement of a recess in a second exemplary embodiment.

FIG. 13B is a view schematically illustrating a section taken along line B-B in FIG. 13A.

FIG. 14 is a sectional view schematically illustrating a solid electrolytic capacitor of a third exemplary embodiment.

FIG. 15A is a top view schematically illustrating an example of arrangement of a recess in the third exemplary embodiment.

FIG. 15B is a view schematically illustrating a section taken along line C-C in FIG. 15A.

### DESCRIPTION OF EMBODIMENT

In recent years, further improvements in reliability (for example, performance stability) of solid electrolytic capacitors are required. In such a circumstance, the present disclosure provides a solid electrolytic capacitor having high reliability.

Hereinafter, exemplary embodiments of a solid electrolytic capacitor according to the present disclosure will be described with reference to examples, but the present disclosure is not limited to the examples to be described below. Although specific numerical values and materials may be provided as examples in the description below, other numerical values and materials may be applied as long as the effects of the present disclosure can be obtained. In this specification, the description “numerical value A to numerical value B” includes a numerical value A and a numerical value B, and can be read as “between numerical value A and numerical value B (inclusive)”. In the following description, in a case where lower limits and upper limits of numerical values related to specific physical properties, conditions, or the like are illustrated, any of the illustrated lower limits and any of the illustrated upper limits can be freely combined unless the lower limit is equal to or more than the upper limit. Hereinafter, the solid electrolytic capacitor may be referred to as an electrolytic capacitor or a capacitor. Hereinafter, the anode lead frame and the cathode lead frame may be collectively referred to as lead frames, and the first buried part and the second buried part may be collectively referred to as a buried part.

### First Exemplary Embodiment

### (Solid Electrolytic Capacitor)

A solid electrolytic capacitor according to the present exemplary embodiment includes a capacitor element including an anode part and a cathode part, an anode lead frame electrically connected to the anode part, a cathode lead frame electrically connected to the cathode part, and an exterior body covering the capacitor element. The anode lead frame includes a first buried part that is a part of the anode lead frame and is buried in the exterior body, and the cathode lead frame includes a second buried part that is a part of the cathode lead frame and is buried in the exterior body. A plurality of recesses are formed on a surface of the buried part (first buried part, second buried part). Hereinafter, the recesses may be referred to as “recesses (C)”.

Oxygen and the like (oxygen, moisture, and the like) easily reach the electrolyte layer through the interface between the buried part and the exterior body. In the capacitor of the present exemplary embodiment, a plurality of recesses (C) are formed on a surface of the buried part. This causes a penetration path of oxygen and the like through the interface between the buried part and the exterior body to be long, and thus oxygen and the like hardly reach the electrolyte layer. In addition, the surface area and the anchor effect of the buried part are increased by the plurality of recesses (C), and the adhesion between the buried part and the exterior body or the like is improved. These can suppress deterioration of the electrolyte layer due to entry of oxygen and the like. As a result, deterioration of the capacitor element can be suppressed, and a solid electrolytic capacitor with high reliability can be obtained.

Among the surfaces of the buried part, a surface in contact with the exterior body may be hereinafter referred to as “first surface”. Among the surfaces of the buried part, a surface in contact with a conductive adhesive layer (described later) may be hereinafter referred to as “second surface”. The plurality of recesses (C) are formed on the first surface and/or the second surface. The plurality of recesses (C) are preferably formed on at least the first surface, and may be formed on the first surface and the second surface.

Average diameter D1 of the opening of recess (C) that does not have a groove shape among the plurality of recesses (C) may be more than or equal to 5 μm, more than or equal to 10 μm, or more than or equal to 30 μm, and may be less than or equal to 200 μm, less than or equal to 100 μm, or less than or equal to 75 μm. Average diameter D1 may be in a range from 5 μm to 200 μm, inclusive (for example, in a range from 10 μm to 100 μm, inclusive).

An equivalent circle diameter can be used as the diameter of the opening of each recess. The equivalent circle diameter is obtained by the following method. First, the opening of the recess is photographed from above view. Next, the obtained image is subjected to image processing to obtain the area of the opening. Next, the equivalent circle diameter is calculated from the obtained area. Average diameter D1 is obtained by calculating the diameter (equivalent circle diameter) of the opening for each of any selected 20 recesses and arithmetically averaging the obtained diameters.

The depth of the plurality of recesses (C) may be more than or equal to 0.5 μm, more than or equal to 2 μm, or more than or equal to 10 μm, and may be less than or equal to 100 μm, less than or equal to 50 μm, or less than or equal to 30 μm. For example, the depths of recesses (C) may be from 2 μm to 50 μm, inclusive. The depths of recesses (C) can be changed by the output of laser light to be emitted to form recesses (C).

Recesses (C) can be formed by irradiating the lead frame with laser light (for example, pulsed laser light). As compared with the case of roughening the surface by sandblasting, etching, or the like, the case of forming recesses (C) by irradiation with laser light has the following advantages. Firstly, since variations in the shape and size of recesses (C) can be reduced, adhesion (airtightness) between the lead frame and the exterior body can be stably secured. Secondly, since the size of recesses (C) can be controlled according to the size of the insulating filler in the exterior body and the size of the conductive particles in the conductive adhesive layer, the adhesion (airtightness) can be further enhanced. Thirdly, since the size, shape, and arrangement pattern of recesses (C) can be changed depending on the position, the adhesion (airtightness) can be further enhanced.

Forming recesses (C) with laser light makes it possible to form the recesses having a uniform size and shape at desired positions. For example, the diameter of the opening of each recess (C) can be controlled to be in a range from 50% to 150%, inclusive, of average diameter D1.

The plurality of recesses (C) are formed in at least one of the first buried part or the second buried part, and may be formed in each of the first buried part and the second buried part.

The plurality of recesses (C) may have similar shapes and sizes. Alternatively, the plurality of recesses (C) may include recesses (C) having different sizes or shapes. For example, the plurality of recesses (C) may include at least one first recess having a groove shape and a plurality of second recesses not having a groove shape. Hereinafter, the first recess and the second recess may be referred to as “first recess (C1)” and “second recess (C2)”, respectively. Recesses (C), including first recess (C1) and second recess (C2), can particularly suppress entry of oxygen or the like.

The first recess having a groove shape may be a linear groove or a non-linear groove. Examples of the non-linear groove include a groove in which the shape of the opening is a zigzag shape or a wavy shape.

The width of the opening of first recess (C1) having a groove shape may be more than or equal to 5 μm, more than or equal to 10 μm, or more than or equal to 20 μm, and may be less than or equal to 200 μm, less than or equal to 50 μm, or less than or equal to 30 μm. For example, the width may be from 5 μm to 50 μm, inclusive. The width of the opening means the maximum length of the opening in a direction perpendicular to the direction in which the first recess (C1) having a groove shape extends (longitudinal direction in the case of a linear groove).

The length of the opening of first recess (C1) having a groove shape may be more than or equal to 15 μm, more than or equal to 50 μm, more than or equal to 100 μm, or more than or equal to 1 mm. The upper limit of the length is not particularly limited, and first recess (C) may be formed over the entire width of the lead frame. That is, the length may be equal to or less than the width of the lead frame. Depending on the size of the electrolytic capacitor, the length may be less than or equal to 10 mm, less than or equal to 1 mm, or less than or equal to 100 μm.

In first recess (C1) having a groove shape, length L1 of the opening along the direction in which the opening extends and width W1 of the opening satisfy 3<L1/W1. Length L1 and width W1 may satisfy 5<L1/W1. L1/W1 has no particular upper limit, and may be less than or equal to 200 (for example, less than or equal to 100). In second recess (C2), length L2 of the opening along the direction in which the opening extends and width W2 of the opening satisfy 1≤ L2/W2≤3. When the opening has a circular shape, L2/W2=1 is satisfied.

Second recess (C2) not having a groove shape may include a recess having a circular opening, may include a recess having a non-circular opening, or may include both. Examples of recess (C2) having a non-circular opening include a recess obtained by forming a plurality of recesses each having a circular opening in such a manner that they partially overlap each other. Examples of the non-circular shape include a shape in which only a small portion of two adjacent circles overlap and a shape in which most of two adjacent circles overlap. Examples of the non-circular shape also include the shape of a locus when the circle is shifted. Examples of the non-circular shape include an elliptical shape, an elongated round shape, an oval shape, and a substantially triangular shape.

The solid electrolytic capacitor according to the present exemplary embodiment may satisfy at least one of the following conditions (1) to (4) as a configuration for lengthening an entry path of oxygen or the like through an interface between the lead frame and the exterior body. The following conditions (1) to (4) can be freely combined and applied to the solid electrolytic capacitor of the present exemplary embodiment.

(1) First recess (C1) having a groove shape extends to intersect longitudinal direction LD of the anode part.

(2) At least one of the plurality of recesses (C) is disposed in a plurality of band-shape regions, and each of the plurality of band-shape regions extends along intersecting direction WD intersecting longitudinal direction LD of the anode part. Hereinafter, the band-shape region may be referred to as “region (R)”.

(3) In the case of (2), the interval between two adjacent recesses (C) in each of the plurality of band-shape regions (R) is shorter than the interval between two adjacent regions (R).

(4) At least one first recess (C1) and at least one second recess (C2) are formed in each of the plurality of band-shape regions (R). A position in intersecting direction WD where first recess (C1) is formed in one region among the plurality of band-shape regions (R) is different from a position in intersecting direction WD where first recess (C1) is formed in another region (R) adjacent to the one region (R).

The side surface of the buried part may be processed to have irregularities. This configuration makes it possible to suppres entry of oxygen or the like through the interface between the side surface of the buried part and the exterior body.

The plurality of recesses (C) may be formed in the entire lead frame. Alternatively, the plurality of recesses (C) may be formed only on the surface of the buried part without being formed on the exposed part exposed from the exterior body. The plurality of recesses (C) may be formed only in a part of the buried part. The proportion (Sc/Sa) of area Sc occupied by the opening of recess (C) in apparent area Sa of the surface of the buried part may be more than or equal to 5%, more than or equal to 10%, more than or equal to 20%, more than or equal to 30%, and may be less than or equal to 90%, less than or equal to 80%, less than or equal to 70%, less than or equal to 60%, 50%, less than or equal to 40%, less than or equal to 30%, or less than or equal to 20%. In this specification, the apparent area of the surface is the area of the surface when it is assumed that the surface is a flat surface without unevenness such as recesses (C), and can be calculated from the outer shape of the target portion. For example, the apparent area of the surface of the buried part can be calculated from the outer shape of the buried part.

The proportion (Sc1/Sa1) of area Sc1 occupied by the openings of recesses (C) formed in the first buried part in apparent area Sa1 of the surface of the first buried part may fall within the range exemplified for the proportion (Sc/Sa). The proportion (Sc2/Sa2) of area Sc2 occupied by the openings of recesses (C) formed in the second buried part in apparent area Sa2 of the surface of the second buried part may fall within the range exemplified for the proportion (Sc/Sa). The proportion (Sc/Sa), the proportion (Sc1/Sa1), and the proportion (Sc2/Sa2) may be the same or different.

The proportion of recesses (C) in the surface of the buried part may be changed depending on the position. For example, the proportion on the first surface in contact with the exterior body may be changed to be differenct from the proportion on the second surface in contact with the conductive adhesive layer. For example, the proportion of recesses (C) in the first surface may be higher than the proportion of recesses (C) in the second surface. In an example, the interval between the plurality of recesses (C) on the first surface is made narrower than the interval between the plurality of recesses (C) on the second surface.

### Example of Configuration of Solid Electrolytic Capacitor

Examples of the configuration and constituent elements of the solid electrolytic capacitor according to the present exemplary embodiment will be described below. The configuration and constituent elements of the solid electrolytic capacitor according to the present exemplary embodiment are not limited to the following examples. An example of the solid electrolytic capacitor according to the present exemplary embodiment includes a capacitor element, an anode lead frame, a cathode lead frame, and an exterior body. These will be described below.

### (Capacitor Element)

The capacitor element includes an anode part, a dielectric layer, and a cathode part. The capacitor element is not particularly limited, and a capacitor element used in a known solid electrolytic capacitor may be used.

The anode part may be formed of an anode body or may include an anode body and an anode wire. The anode body may be a porous sintered body or a metal foil having a porous surface. The dielectric layer is formed on a surface of the anode body. The cathode part includes an electrolyte layer (solid electrolyte layer) and a cathode layer. The electrolyte layer is disposed between the dielectric layer formed on the surface of the anode body and the cathode layer. These constituent elements are not particularly limited, and constituent elements used for known solid electrolytic capacitors may be applied. Examples of these constituent elements will be described below.

### (Anode Body)

The anode body may be formed by sintering material particles. Examples of the material particles include particles of a valve metal, particles of an alloy containing a valve metal, and particles of a compound containing a valve metal. One of these kinds of particles may be used alone, or two or more of these kinds may be used in mixture. Alternatively, a metal foil having a valve action may be used as the anode body. Examples of the valve metal include titanium (Ti), tantalum (Ta), niobium (Nb), and aluminum (Al). A preferred example of the anode body as a sintered body is a sintered body of tantalum. A preferred example of the anode body as a metal foil is an aluminum foil.

The dielectric layer formed on the surface of the anode body is not particularly limited, and it may be formed by a known method. For example, the dielectric layer may be formed by anodizing the surface of the anode body.

(Anode wire)

As the anode wire, a wire made of metal can be used. Examples of the material of the anode wire include the above-described valve metals, copper, and aluminum alloy. The anode wire is partially buried in the anode body, and the remaining part protrudes from an end surface of the anode body.

### (Electrolyte Layer)

The electrolyte layer (solid electrolyte layer) is not particularly limited, and a solid electrolyte layer used in a known solid electrolytic capacitor may be applied. The electrolyte layer is disposed to cover at least a part of the dielectric layer. The electrolyte layer may be formed using a manganese compound or a conductive polymer. Examples of the conductive polymer include polypyrrole, polythiophene, polyaniline, and derivatives of these. These polymers may be used alone or in combination of a plurality of polymers. In addition, the conductive polymer may be a copolymer of two or more kinds of monomers. The derivative of the conductive polymer means a polymer having the conductive polymer as a basic skeleton. For example, examples of the derivative of polythiophene include poly(3,4-ethylenedioxythiophene).

A dopant is preferably added to the conductive polymer. The dopant can be selected according to the conductive polymer, and a known dopant (for example, a polymer dopant) may be used. Examples of the dopant include naphthalenesulfonic acid, p-toluenesulfonic acid, polystyrenesulfonic acid, and salts of these. An example of the electrolyte layer is formed using poly(3,4-ethylenedioxythiophene) (PEDOT) doped with polystyrenesulfonic acid (PSS).

The electrolyte layer containing the conductive polymer may be formed by polymerizing a monomer as a raw material on the dielectric layer. Alternatively, the electrolyte layer may be formed by disposing a liquid containing the conductive polymer (and a dopant as necessary) to the dielectric layer and then drying the liquid.

### (Cathode Layer)

The cathode layer is a layer having conductivity and is disposed to cover at least a part of the electrolyte layer. The cathode layer includes a cathode lead-out layer having conductivity. The cathode layer may include another conductive layer (for example, a carbon layer) disposed between the electrolyte layer and the cathode lead-out layer. For example, the cathode layer may include a carbon layer formed on the electrolyte layer and a cathode lead-out layer formed on the carbon layer. The cathode lead-out layer may be formed of a metal paste (for example, a silver paste) containing metal particles (for example, silver particles) and a resin, or may be formed of a known silver paste. The carbon layer is a layer containing carbon, and it may be formed of a conductive carbon material such as graphite and a resin.

### (Anode Lead Frame and Cathode Lead Frame)

The lead frames (the anode lead frame and the cathode lead frame) include a base material. The base material is made of metal (copper, copper alloy, and the like). The thickness of the base material is not particularly limited and may be in a range from 25 μm to 200 μm, inclusive (for example, in a range from 25 μm to 100 μm, inclusive). The lead frames may include a base material and a plating layer formed on the base material.

The plating layer is formed of a metal (including an alloy) such as nickel, gold, palladium, tin, or copper, and may include a nickel layer, a gold layer, a palladium layer, a tin layer, a copper layer, or the like. For example, the plating layer may be stacked on the base material in the order of a nickel layer, a gold layer, and a palladium layer. The plating layer can be formed by a known plating method.

When the plating layer is formed on the surface of the base material, a plurality of recesses may be formed on the base material by irradiating the base material with laser light, and then the plating layer may be formed on the surface of the base material. Since the plating layer is thin, a portion of the recess formed on the base material becomes the recess (C). Alternatively, a plurality of recesses (C) may be formed after a plating layer is formed on the surface of the base material. In the latter case, the recesses (C) may be formed in such a manner that the base material is exposed.

As described above, the recesses (C) are formed in the lead frames. The anode lead frame is electrically connected to the anode part. The anode lead frame includes a first buried part buried in the exterior body and an exposed part exposed from the exterior body. The first buried part and the anode part may be connected by welding or the like. At least a part of the exposed part functions as a terminal part. The terminal part is a part where soldering or the like is performed.

The cathode lead frame is electrically connected to the cathode part. The cathode lead frame includes a second buried part buried in the exterior body and an exposed part exposed from the exterior body. The second buried part and the cathode part may be connected by a conductive adhesive layer. At least a part of the exposed part functions as a terminal part. The terminal part is a part where soldering or the like is performed.

### (Conductive Adhesive Layer)

The conductive adhesive layer connecting the second buried part of the cathode lead frame and the cathode part contains conductive particles. Examples of the conductive particles include metal particles (for example, silver particles). The conductive adhesive layer can be formed using a metal paste (for example, a silver paste) containing metal particles and a resin.

### (Exterior Body)

The exterior body is disposed around the capacitor element so that the capacitor element is not exposed from the surface of the electrolytic capacitor. Further, the exterior body is disposed to cover the first buried part of the anode lead frame and the second buried part of the cathode lead frame. The exterior body usually contains a resin (insulating resin) and an insulating filler.

The exterior body can be formed of a resin composition including an insulating resin and an insulating filler (for example, an inorganic filler). The resin composition may include a curing agent, a polymerization initiator, a catalyst, and the like in addition to the insulating resin and the insulating filler. Examples of the insulating resin include insulating thermosetting resin and insulating thermoplastic resin. Specific examples of the insulating resin include epoxy resin, phenol resin, urea resin, polyimide, polyamide-imide, polyurethane, diallyl phthalate, unsaturated polyester, polyphenylene sulfide (PPS), and polybutylene terephthalate (PBT).

Examples of the insulating filler include insulating particles and insulating fibers. Examples of the insulating material forming the insulating filler include insulating compounds (e.g., oxides) such as silica and alumina, glass, and mineral materials (e.g., talc, mica, or clay). The insulating filler contained in the exterior body may be one kind or two or more kinds.

### (Method for Producing Solid Electrolytic Capacitor)

A production method of the present exemplary embodiment for producing a solid electrolytic capacitor will be described below with reference to examples. Hereinafter, the production method may be referred to as “production method (M)”. According to production method (M), the solid electrolytic capacitor of the present exemplary embodiment can be produced. However, the solid electrolytic capacitor of the present exemplary embodiment may be produced by a method other than production method (M) described below. The matters described for the solid electrolytic capacitor of the present exemplary embodiment can be applied to the following production method (M), and thus redundant description may be omitted. In addition, the matters described in the following production method (M) may be applied to the solid electrolytic capacitor according to the present exemplary embodiment.

Production method (M) is a method for producing a solid electrolytic capacitor including a capacitor element including an anode part and a cathode part, an anode lead frame electrically connected to the anode part, and a cathode lead frame electrically connected to the cathode part. The anode lead frame includes a first buried part that is a part of the anode lead frame, and the cathode lead frame includes a second buried part that is a part of the cathode lead frame. Production method (M) includes step (i), step (ii), and step (iii) in this order. These steps will be described below.

Step (i) includes a step of forming a plurality of recesses (C) on a surface of the buried part (first buried portion, second buried portion) by irradiating the buried part with laser light a plurality of times.

The plurality of recesses (C) may all be formed under the same condition (for example, the same laser light). Alternatively, some of the plurality of recesses (C) may be formed under different conditions (for example, different laser light). In such a case, the recesses formed under different conditions may have different sizes or different shapes. A plurality of recesses may be formed on the surfaces of the buried part and the exposed part by irradiating not only the buried part but also the exposed part with laser light.

Recess (C) can be formed using a known laser processing device capable of forming a recess in metal. The laser light to be emitted is not particularly limited as long as recess (C) can be formed. The wavelength of the laser light may be less than or equal to 1100 nm, less than or equal to 700 nm (for example, less than or equal to 600 nm), or more than or equal to 300 nm (for example, more than or equal to 350 nm). Using laser light having a short wavelength makes it possible to suppress a temperature rise of the lead frames when recess (C) is formed. Suppressing a temperature rise of the lead frames makes it possible to suppress deterioration (for example, oxidation) of the surfaces of the lead frames. The wavelength of the laser light may be 1064 nm (near infrared laser), 532 nm (visible light laser), or 355 nm (ultraviolet laser). The plurality of recesses (C) may be recesses formed by irradiation with laser light having a wavelength of from 300 nm to 1100 nm, inclusive (for example, from 300 nm to 600 nm, inclusive).

The plurality of recesses (C) may be formed by scanning laser light. Alternatively, the formation may be performed by moving a laser processing machine or the lead frames.

The laser light may be pulse laser light or continuous wave laser light (CW laser light). The recess having a circular opening may be formed by irradiation with pulsed laser light. The recess having a non-circular opening may be formed by irradiating pulsed laser light a plurality of times in such a manner that a part of the irradiation parts overlaps. Alternatively, the recess having a non-circular opening may be formed by irradiation with CW laser light (continuous wave laser light).

A preferred example of the laser light for forming recess (C) is laser light having a wavelength of 355 nm. The light source of the laser light having a wavelength of 355 nm is not particularly limited, and a third harmonic such as a YVO₄ laser may be used.

Step (ii) is a step of electrically connecting the first buried part to the anode part of the capacitor element and electrically connecting the second buried part to the cathode part of the capacitor element. These connection methods are not particularly limited, and known connection methods may be used. For example, the first buried part may be connected to the anode part by welding. In step (ii), the second buried part may be electrically connected to the cathode part via a conductive adhesive layer containing conductive particles. Specifically, the cathode part and the second buried part may be connected using a metal paste. When recess (C) is formed on the surface of the second buried part that is in contact with the conductive adhesive layer, the conductive adhesive layer enters recess (C).

Step (iii) is a step of covering the buried part and the capacitor element with an exterior body. Step (iii) can be performed by a known method. Specifically, step (iii) can be performed by covering the buried part and the capacitor element with a resin composition to be an exterior body, and then curing the resin composition. At this time, the exterior body enters the inside of recess (C) formed in the buried part. As the exterior body, an exterior body containing a resin (insulating resin) and an insulating filler can be used. The solid electrolytic capacitor can be thus produced.

Hereinafter, an example of the solid electrolytic capacitor according to the present disclosure will be specifically described with reference to the drawings. The above-described constituent elements can be applied to the constituent elements of the capacitor of the example described below. The capacitor of the example described below can be changed based on the above description. A matter described below may be applied to the exemplary embodiment described above. In the exemplary embodiments to be described below, constituent elements that are not essential to the solid electrolytic capacitor according to the present disclosure may be omitted.

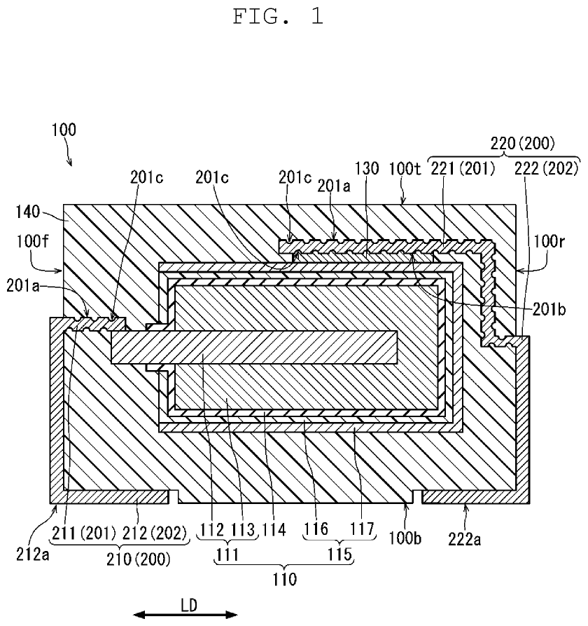

FIG. 1 schematically illustrates a sectional view of solid electrolytic capacitor 100 (hereinafter, may be referred to as “electrolytic capacitor 100”) of a first exemplary embodiment. In the first embodiment, an example in which the anode part includes an anode body and an anode wire will be described.

Electrolytic capacitor 100 includes capacitor element 110, lead frame 200, conductive adhesive layer 130, and exterior body 140. Lead frame 200 includes anode lead frame 210 and cathode lead frame 220.

Capacitor element 110 includes anode part 111, dielectric layer 114, and cathode part 115. Anode part 111 includes anode body 113 and anode wire 112. Anode body 113 is a porous sintered body having a rectangular-parallelepiped shape, and dielectric layer 114 is formed on a surface of the anode body.

A part of anode wire 112 protrudes from one end surface of anode body 113 toward front surface 100f of electrolytic capacitor 100. The other part of anode wire 112 is buried in anode body 113. Anode wire 112 extends along longitudinal direction LD of anode body 113. Cathode part 115 includes electrolyte layer 116 disposed to cover at least a part of dielectric layer 114, and cathode layer 117 formed to cover at least a part of electrolyte layer 116.

Anode lead frame 210 includes first buried part 211 buried in exterior body 140 and exposed part 212 exposed from exterior body 140. Exposed part 212 includes terminal part 212a that functions as a terminal on the anode side. The surface where terminal part 212a is present may be referred to as bottom surface 100b of electrolytic capacitor 100. The surface facing bottom surface 100b may be referred to as upper surface 100t of electrolytic capacitor 100. The surface facing front surface 100f may be referred to as rear surface 100r of electrolytic capacitor 100.

Cathode lead frame 220 includes second buried part 221 buried in exterior body 140 and exposed part 222 exposed from exterior body 140. Exposed part 222 includes terminal part 222a that functions as a terminal on the cathode side. Hereinafter, first buried part 211 and second buried part 221 may be collectively referred to as buried part 201, and exposed part 212 and exposed part 222 may be collectively referred to as exposed part 202. Lead frame 200 includes buried part 201 and exposed part 202.

The overall shape and arrangement of lead frame 200 and the connection positions between lead frame 200 and anode part 111 and cathode part 115 are not limited to the example illustrated in FIG. 1. For example, cathode lead frame 220 may be connected to cathode part 115 at a portion other than upper surface 100t (for example, a portion on bottom surface 100b side or a portion on rear surface 100r side).

Buried part 201 includes first surface 201a that is in contact with exterior body 140. Further, the buried part 201 includes second surface 201b that is a surface of second buried part 221 and is in contact with conductive adhesive layer 130. Second surface 201b is electrically connected to cathode part 115 (more specifically, cathode layer 117) by conductive adhesive layer 130.

A plurality of recesses are formed on a surface of the buried part of the solid electrolytic capacitor according to the present exemplary embodiment at intervals. In the first exemplary embodiment, an example in which a plurality of recesses 201c are formed on both of first surface 201a and second surface 201b will be described. Further, recesses 201c are formed on both of first surface 201a of anode lead frame 210 and first surface 201a of cathode lead frame 220.

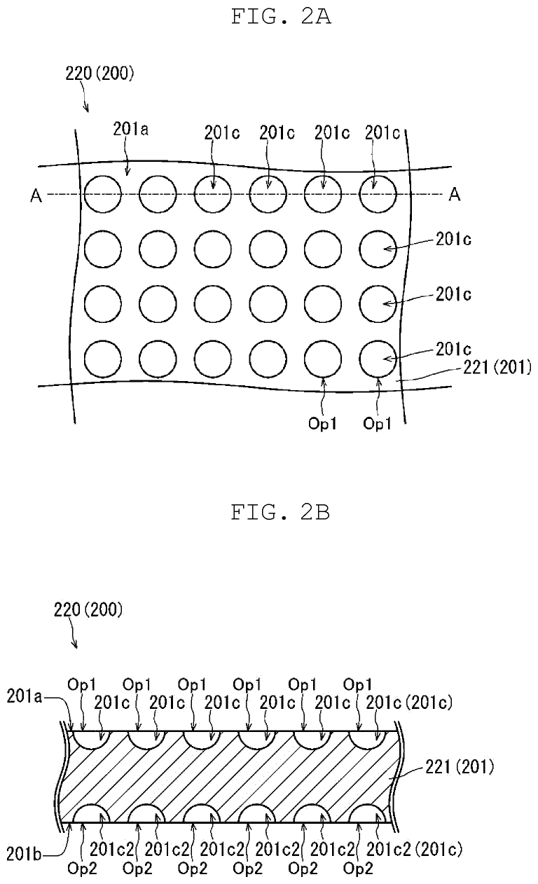

FIGS. 2A and 2B illustrate an example of arrangement of recesses 201c in buried part 201 (first buried part 211 and second buried part 221). FIG. 2A is a view of buried part 201 as viewed from upper surface 100t side. A section taken along line A-A in FIG. 2A is illustrated in FIG. 2B. In the example illustrated in FIG. 2A, the plurality of recesses 201c are disposed in a matrix at regular intervals. In the example illustrated in FIGS. 2A and 2B, the arrangement of recesses 201c on one surface of buried part 201 is the same as the arrangement of recesses 201c on the other surface. The arrangement of the plurality of recesses 201c is not limited to the arrangement illustrated in FIGS. 2A and 2B, and may be another arrangement. In FIG. 2B, the sectional shape of recess 201c is schematically a hemispherical shape, but the sectional shape of recess 201c does not have to be a hemispherical shape. In the example illustrated in FIGS. 2A and 2B, the shapes of openings Op1 and Op2 of recesses 201c are circular shapes.

As described above, forming recess 201c can suppress deterioration (for example, an increase in ESR) of capacitor element 110. Thus, the reliability of the electrolytic capacitor 100 can be improved. In addition, the resistance between conductive adhesive layer 130 and cathode lead frame 220 can be reduced by forming recess 201c on a surface of second buried part 221 of cathode lead frame 220, the surface being in contact with conductive adhesive layer 130. As a result, characteristics of electrolytic capacitor 100 can be improved.

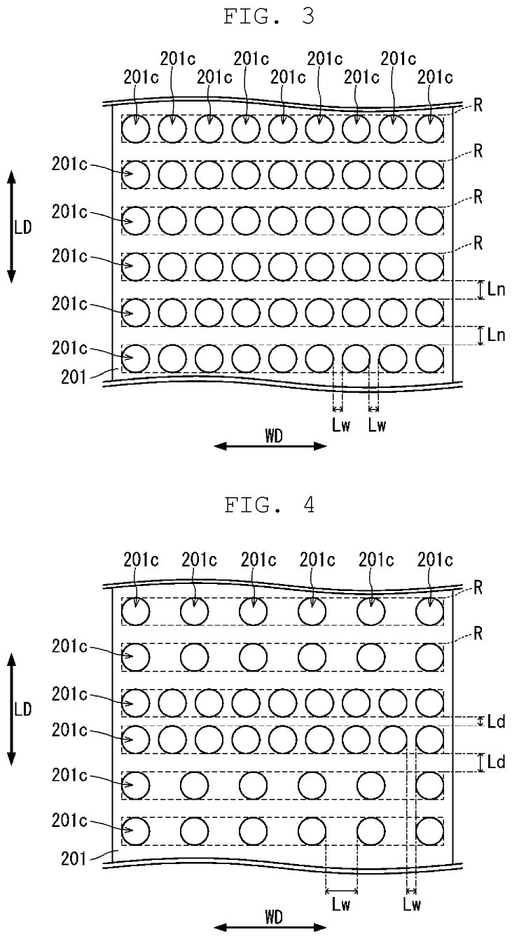

A part of other arrangement examples of recess 201c is illustrated in FIGS. 3 to 10. In the arrangement of FIG. 3, at least one of recesses 201c are disposed in the plurality of band-shape regions R. Each of the plurality of regions R extends along intersecting direction WD intersecting longitudinal direction LD of anode part. FIG. 3 illustrates an example of a case where intersecting direction WD is orthogonal to longitudinal direction LD. In region R, an interval between recesses 201c in intersecting direction WD is defined as interval Lw. An interval between two adjacent regions R is defined as Ln. As described above, Lw may be shorter than Ln.

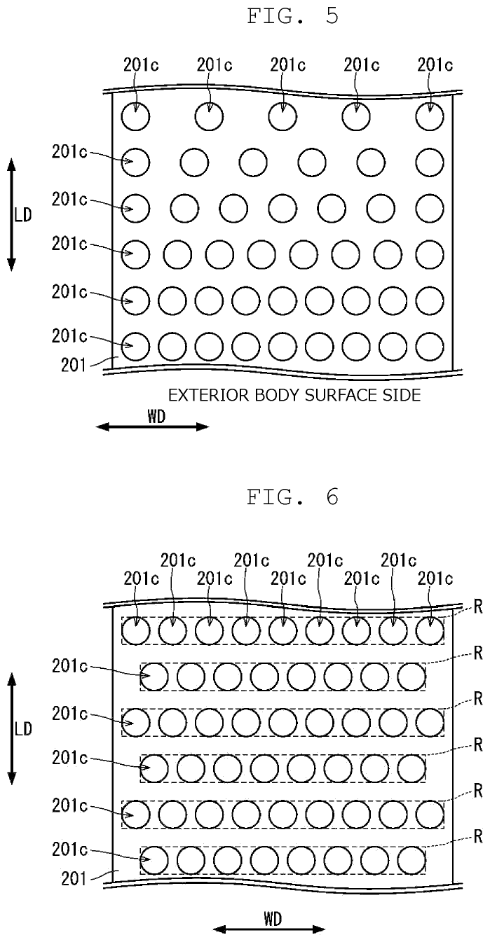

In the example illustrated in FIG. 4, the interval between the plurality of recesses 201c varies depending on the location. For example, the interval between recesses 201c may be narrowed in a portion where adhesion is desired to be improved or a portion where suppression of entry of oxygen or the like is particularly important. For example, the interval between recesses 201c on first surface 201a that is in contact with exterior body 140 may be narrower than the interval between recesses 201c on second surface 201b that is in contact with conductive adhesive layer 130. Alternatively, the interval between recesses 201c in a portion close to the surface of exterior body 140 may be made narrower than the interval between recesses 201c present on the inner side. An example of such an arrangement is illustrated in FIG. 5. In the example illustrated in FIG. 5, the interval between recesses 201c is narrowed on the exterior body surface side.

Recesses 201c may be disposed in a matrix or not in a matrix. In the example illustrated in FIG. 6, the position of recess 201c in intersecting direction WD differs depending on region R. In the example illustrated in FIG. 6, the plurality of recesses 201c are disposed in a staggered manner. The arrangement is not limited to the arrangement of FIG. 6, and the arrangement of at least one of recesses 201c does not have to be a matrix arrangement even in other arrangements.

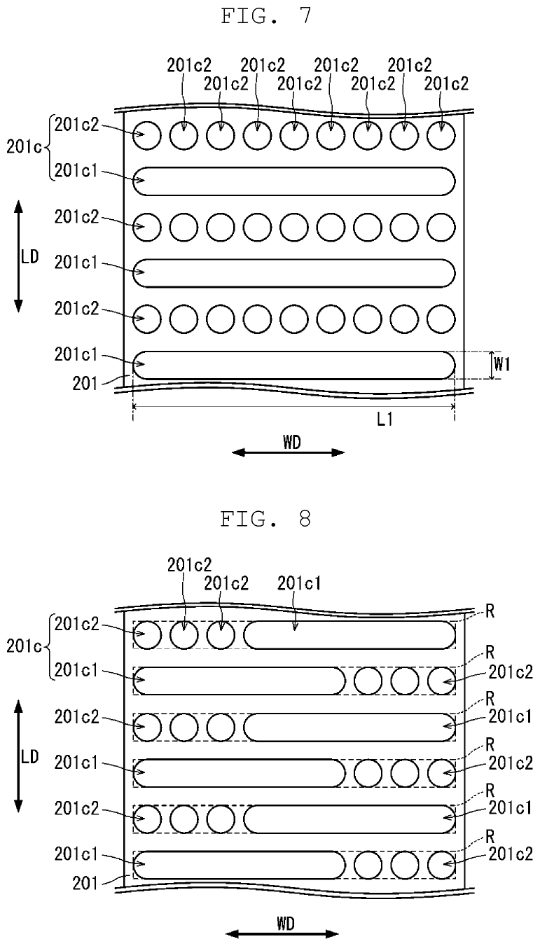

Some of the plurality of recesses 201c may include at least one first recess 201c1 having a groove shape and a plurality of second recesses 201c2 not having a groove shape. An example of the arrangement of such recesses 201c is illustrated in FIGS. 7 and 8.

In the example of FIG. 7, the plurality of recesses 201c include first recess 201c1 having a groove shape and a plurality of second recesses 201c2 not having a groove shape. First recess 201c1 extends linearly to intersect longitudinal direction LD. First recess 201c1 extends over substantially the entire width of buried part 201. FIG. 7 illustrates width W1 of the opening and length L1 of the opening of first recess 201c1 along the direction in which the opening is elonged. Length L1 and width W1 satisfy the above-described relationship.

First recess 201c1 may be shorter. An example of an arrangement using such first recess 201c1 is illustrated in FIG. 8. In the example of FIG. 8, the plurality of recesses 201c are disposed in band-shape region R. In each region R, one first recess 201c1 and a plurality of second recesses 201c2 are disposed. Recess 201c2 has a circular opening.

The position in intersecting direction WD where first recess 201c1 is formed in one region R among the plurality of band-shape regions R is different from the position in intersecting direction WD where first recess 201c1 is formed in another region R adjacent to the one region R. Recess 201c1 is preferably disposed such that a line passing through two adjacent regions R and orthogonal to intersecting direction WD always passes through at least one recess 201c1. This configuration can particularly suppress entry of oxygen or the like.

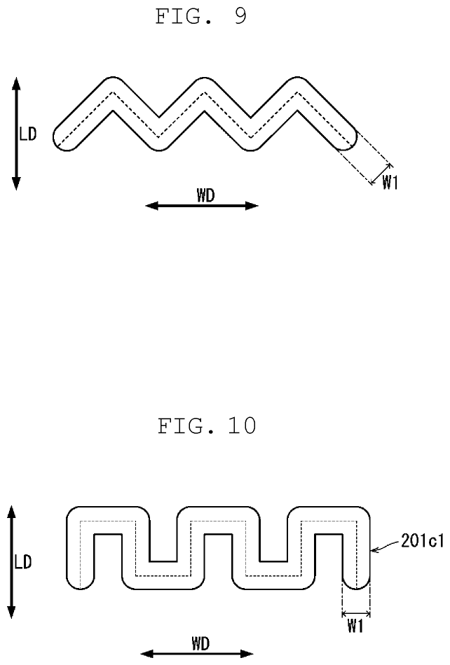

In the illustrated example, first recess 201c1 having a groove shape extends linearly. However, at least one first recess 201c1 does not have to be linear. An example of the shape of the opening of such first recess 201c1 is illustrated in FIGS. 9 and 10.

Each of first recesses 201c1 illustrated in FIGS. 9 and 10 extends in a zigzag manner. Length L1 of the opening of first recess 201c1 along the direction in which the opening extends is a length along the dotted lines in FIGS. 9 and 10. The dotted lines illustrated in FIGS. 9 and 10 are lines passing through the center of the opening in the width direction.

In the illustrated example, the opening of second recess 201c2 has a circular shape. However, the shape of the opening of recess 201c (the shape of the opening of recess 201c2) may be the above-described other shape other than a circular shape.

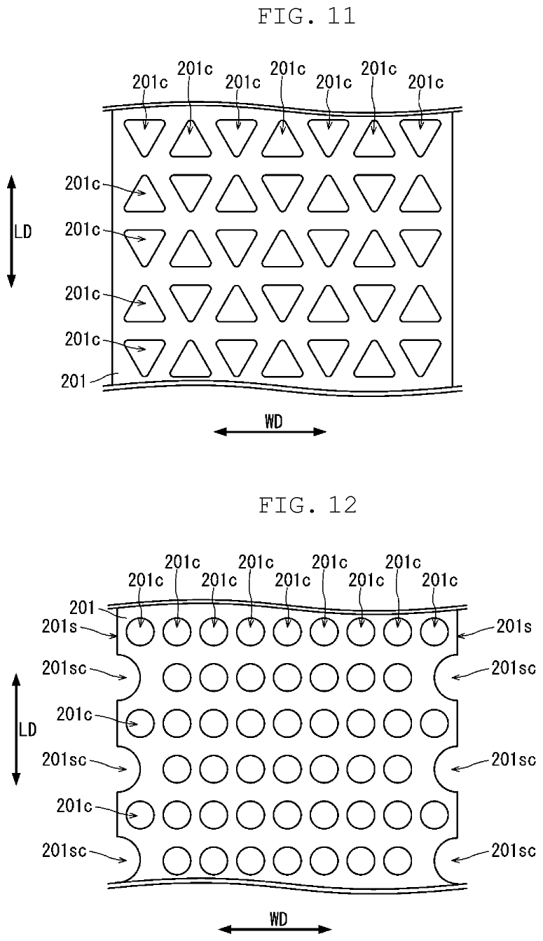

FIG. 11 illustrates an example of recess 201c in which the opening has a substantially triangular shape. The opening of recess 201c in FIG. 11 has a substantially triangular shape.

The side surface of buried part 201 may be processed to have irregularities. A top view of an example of such buried part 201 is illustrated in FIG. 12. Side surface 201s of buried part 201 illustrated in FIG. 12 is processed to have irregularities. Specifically, on side surface 201s, a plurality of recesses 201sc and protrusions present between the recesses are formed. Such irregularities may be formed when the shape of the lead frame is formed by punching or laser irradiation.

The features of the arrangement and shape illustrated in each of the above drawings can be freely combined as long as there is no contradiction.

### Second Exemplary Embodiment

Hereinafter, a configuration of a second embodiment will be described, but the description of the same configuration as that of the first exemplary embodiment may be omitted.

### (Solid Electrolytic Capacitor)

A solid electrolytic capacitor according to the present exemplary embodiment includes a capacitor element including an anode part and a cathode part, an anode lead frame electrically connected to the anode part, a cathode lead frame electrically connected to the cathode part, and an exterior body covering the capacitor element. The anode lead frame includes a first buried part that is a part of the anode lead frame and is buried in the exterior body, and the cathode lead frame includes a second buried part that is a part of the cathode lead frame and is buried in the exterior body. A plurality of recesses are formed on a surface of the buried part (first buried part, second buried part). Hereinafter, the recesses may be referred to as “recesses (C)”. The lead frame (anode lead frame, cathode lead frame) includes a base material and a plating layer formed on a surface of the base material. No plating layer is present in the plurality of recesses. The plating layer is present in a region between the plurality of recesses on the surface of the buried part. In other words, the plurality of recesses are formed in such a manner as to remove a part of the plating layer.

Oxygen and the like (oxygen, moisture, and the like) easily reach the electrolyte layer through the interface between the buried part and the exterior body. In the capacitor of the present exemplary embodiment, a plurality of recesses (C) are formed on a surface of the buried part. This causes a penetration path of oxygen and the like through the interface between the buried part and the exterior body to be long, and thus oxygen and the like hardly reach the electrolyte layer. In addition, the surface area and the anchor effect of the buried part are increased by the plurality of recesses (C), and the adhesion between the buried part and the exterior body is improved. These can suppress deterioration of the electrolyte layer due to entry of oxygen and the like. As a result, deterioration of the capacitor element can be suppressed, and a solid electrolytic capacitor with high reliability can be obtained.

Further, in the capacitor of the present exemplary embodiment, a plating layer is formed on the surface of the buried part of the lead frame. In this case, the adhesion between the plating layer and the exterior body can be improved more than the adhesion between the base material of the lead frame and the exterior body. Thus, deterioration of the capacitor element can be particularly suppressed.

Normally, the plating layer of the lead frame is formed to improve solderability at a terminal part (described later) of an exposed part of the lead frame. Forming the plating layer only on the terminal part complicates the manufacturing process, and thus, the plating layer is usually formed not only on the exposed part but also on the buried part.

The plating layer is usually formed on both the base material of the anode lead frame and the base material of the cathode lead frame. The plurality of recesses (C) are preferably formed in both of the first buried part of the anode lead frame and the second buried part of the cathode lead frame. However, the plurality of recesses (C) may be formed only in any one of the buried parts. Recess (C) may be formed on both main surfaces of the lead frame, or may be formed only on one main surface of the lead frame.

Among the surfaces of the buried part, a surface that is in contact with the exterior body may be hereinafter referred to as “first surface”, and among the surfaces of the buried part, a surface that is in contact with a conductive adhesive layer (described later) may be hereinafter referred to as “second surface”. The plurality of recesses (C) are formed on the first surface and/or the second surface. The plurality of recesses (C) are preferably formed on at least the first surface, and may be formed on the first and second surfaces.

The plurality of recesses (C) may be formed on a surface of the first buried part and a surface of the second buried part. Further, the surface of the buried part (first and second buried parts) on which the plurality of recesses (C) are not formed may be covered with a plating layer.

The average thickness of the plating layer may be more than or equal to 0.1 μm, or more than or equal to 0.5 μm, and may be less than or equal to 50 μm, or less than or equal to 10 μm. For example, the average thickness of the plating layer may be from 0.1 μm to 10 μm, inclusive.

The average thickness of the plating layer is determined, for example, by measuring thicknesses at any ten points from a photograph of a section and arithmetically averaging the measured thicknesses. The thicknesses at any ten points may be measured using an X-ray fluorescence spectrometer.

Regarding the shapes of the plurality of recesses (C) and the method for forming recesses (C), the description of the same configuration as those described in the first exemplary embodiment will be omitted. The depths of the plurality of recesses (C) are preferably larger than the average thickness of the plating layer. The depths of recesses (C) can be changed by the output of laser light to be emitted to form recesses (C).

The base material of the lead frame may be exposed at the bottoms of the plurality of recesses (C). Forming recess (C) in such a manner as to expose the base material allows the exterior body to be in close contact with both the base material and the plating layer on the inner surface of recess (C). As a result, peeling of the plating layer from the base material is suppressed by the exterior body.

The plating layer is formed of a metal (including an alloy) such as nickel, gold, palladium, tin, or copper, and may include a nickel layer, a gold layer, a palladium layer, a tin layer, a copper layer, or the like. For example, a plating layer may be formed on the lead frame in the order of a nickel layer, a gold layer, and a palladium layer. The plurality of recesses (C) may include a recess having a circular opening, may include a recess having a non-circular opening, or may include both. Examples of the recess having a non-circular opening include a recess obtained by forming a plurality of recesses each having a circular opening in such a manner that they partially overlap each other. Examples of the non-circular shape include a shape in which only a small portion of two adjacent circles overlap and a shape in which most of two adjacent circles overlap. Examples of the non-circular shape also include the shape of a locus when the circle is shifted. Examples of the non-circular shape include an elliptical shape, an elongated round shape, and an oval shape. The plurality of recesses (C) may include at least one recess having a groove shape.

Area S1 of the surface of the buried part covered with the plating layer may be from 10% to 90%, inclusive, of area S0 of the surface of the buried part. Area S1 may be more than or equal to 10%, more than or equal to 20%, more than or equal to 30%, or more than or equal to 40% of the area S0. Area S1 may be less than or equal to 90%, less than or equal to 80%, less than or equal to 70%, or less than or equal to 60% of the area S0. Each of area S1 and area S0 is an apparent area. In this specification, the apparent area of the surface is the area of the surface when it is assumed that the surface is a flat surface without unevenness such as recesses (C), and can be calculated from the outer shape of the target portion. For example, the apparent area of the surface of the buried part can be calculated from the outer shape of the buried part.

### Example of Configuration of Solid Electrolytic Capacitor

Examples of configurations and constituent elements of the solid electrolytic capacitor according to the present exemplary embodiment will be described below, but description of the same configurations as those described in the first exemplary embodiment will be omitted.

### (Anode Lead Frame and Cathode Lead Frame)

The lead frame (the anode lead frame and the cathode lead frame) includes a base material and a plating layer formed on the base material. The base material is made of metal (copper, copper alloy, and the like). The thickness of the base material is not particularly limited and may be in a range from 25 μm to 200 μm, inclusive (for example, in a range from 25 μm to 100 μm, inclusive).

The plating layer is formed of a metal (including an alloy) such as nickel, gold, palladium, tin, or copper, and may include a nickel layer, a gold layer, a palladium layer, a tin layer, a copper layer, or the like. For example, the plating layer may be stacked on the base material in the order of a nickel layer, a gold layer, and a palladium layer. The plating layer can be formed by a known plating method.

As described above, the recesses (C) are formed in the lead frames. The anode lead frame is electrically connected to the anode part. The anode lead frame includes a first buried part buried in the exterior body and an exposed part exposed from the exterior body. The first buried part and the anode part may be connected by welding or the like. At least a part of the exposed part functions as a terminal part. The terminal part is a part where soldering or the like is performed.

The cathode lead frame is electrically connected to the cathode part. The cathode lead frame includes a second buried part buried in the exterior body and an exposed part exposed from the exterior body. The second buried part and the cathode part may be connected by a conductive adhesive layer. At least a part of the exposed part functions as a terminal part. The terminal part is a part where soldering or the like is performed.

### (Method for Producing Solid Electrolytic Capacitor)

A production method of the present exemplary embodiment for producing a solid electrolytic capacitor will be described below by way of example, but the description of the same configuration as the configuration described in the first exemplary embodiment will be omitted.

Production method (M) is a method for producing a solid electrolytic capacitor including a capacitor element including an anode part and a cathode part, an anode lead frame electrically connected to the anode part, and a cathode lead frame electrically connected to the cathode part. The anode lead frame includes a first buried part that is a part of the anode lead frame, and the cathode lead frame includes a second buried part that is a part of the cathode lead frame. Production method (M) includes step (i), step (ii), and step (iii) in this order. These steps will be described below.

Step (i) includes a step of forming a plurality of recesses (C) on a surface of the buried part (first buried part, the second buried part described above) by irradiating the buried part with laser light a plurality of times. Step (i) may include step (i-a) and step (i-b) described below in this order.

Step (i-a) is a step of preparing a lead frame (anode lead frame, cathode lead frame) including a base material and a plating layer formed on the base material. The plating layer is formed on at least a surface of a terminal part and a surface of the buried part in the surface of the base material. Usually, the plating layer is formed on the entire surface of the base material. Step (i-a) may be performed by plating a base material (for example, a metal sheet including a portion to be a lead frame) to be a lead frame. The method for forming the plating layer is not limited, and the plating layer may be formed by a known method.

Step (i-b) is a step of irradiating the plating layer on the buried part with laser light a plurality of times to form the plurality of recesses (C) with the plating layer remaining in a region between the plurality of recesses (C). In step (i-b), it is preferable to form the plurality of recesses (C) in such a manner that the base material is exposed at the bottoms of the plurality of recesses. That is, step (i-b) may be a step of forming a plurality of recesses (C) in such a manner as to expose the base material by irradiating the plating layer on the buried part with laser light a plurality of times. The plating layer is present on the surface of the buried part where the recess (C) is to be formed. Thus, when recess (C) is formed, at least a part of the plating layer at the portion of recess (C) is removed, and the plating layer other than the portion of recess (C) remains without being removed. When recess (C) is formed to reach the base material, the plating layer at the portion of recess (C) is removed, while the plating layer remains on the surface between the plurality of recesses (C).

The plurality of recesses (C) may all be formed under the same condition (for example, the same laser light). Alternatively, some of the plurality of recesses (C) may be formed under different conditions (for example, different laser light). In such a case, the recesses formed under different conditions may have different sizes or different shapes. A plurality of recesses may be formed on the surfaces of the buried part and the exposed part by irradiating not only the buried part but also the exposed part with laser light.

Recess (C) can be formed using a known laser processing device capable of forming a recess in metal. The laser light to be emitted is not particularly limited as long as recess (C) can be formed. The wavelength of the laser light may be less than or equal to 1100 nm, less than or equal to 700 nm (for example, less than or equal to 600 nm), or more than or equal to 300 nm (for example, more than or equal to 350 nm). Using laser light having a short wavelength makes it possible to suppress a temperature rise of the lead frames when recess (C) is formed. Suppressing a temperature rise of the lead frames makes it possible to suppress deterioration (for example, oxidation) of the surfaces of the lead frames. The wavelength of the laser light may be 1064 nm (near infrared laser), 532 nm (visible light laser), or 355 nm (ultraviolet laser). The plurality of recesses (C) may be recesses formed by irradiation with laser light having a wavelength of from 300 nm to 1100 nm, inclusive (for example, from 300 nm to 600 nm, inclusive).

The plurality of recesses (C) may be formed by scanning laser light. Alternatively, the formation may be performed by moving a laser processing machine or the lead frames.

The laser light may be pulse laser light or continuous wave laser light (CW laser light). The recess having a circular opening may be formed by irradiation with pulsed laser light. The recess having a non-circular opening may be formed by irradiating pulsed laser light a plurality of times in such a manner that a part of the irradiation parts overlaps. Alternatively, the recess having a non-circular opening may be formed by irradiation with CW laser light (continuous wave laser light).

A preferred example of the laser light for forming recess (C) is laser light having a wavelength of 355 nm. The light source of the laser light having a wavelength of 355 nm is not particularly limited, and a third harmonic such as a YVO₄ laser may be used.

In an example of steps (i-a) and (i-b), first, a metal sheet including portions to be a plurality of lead frames and provided with a plating layer is prepared. Next, a portion of the metal sheet where recess (C) is to be formed is irradiated with laser light to form recess (C). Before the formation of the plating layer or after the formation of the plating layer and before or after the irradiation of laser light, an unnecessary portion of the metal sheet is removed by known metal processing. After the irradiation of laser light, a portion of the lead frames that needs to be bent is bent by known metal processing. The metal sheet thus processed is used in the next step (ii).

Step (ii) is a step of electrically connecting the first buried part to the anode part of the capacitor element and electrically connecting the second buried part to the cathode part of the capacitor element. These connection methods are not particularly limited, and known connection methods may be used. For example, the first buried part may be connected to the anode part by welding. In step (ii), the second buried part may be electrically connected to the cathode part via a conductive adhesive layer containing conductive particles. Specifically, the cathode part and the second buried part may be connected using a metal paste. When recess (C) is formed on the surface of the second buried part that is in contact with the conductive adhesive layer, the conductive adhesive layer enters recess (C).

Step (iii) is a step of covering the buried part and the capacitor element with an exterior body. Step (iii) can be performed by a known method. Specifically, step (iii) can be performed by covering the buried part and the capacitor element with a resin composition to be an exterior body, and then curing the resin composition. At this time, the exterior body enters the inside of the recess formed in the buried part. As the exterior body, an exterior body containing a resin (insulating resin) and an insulating filler can be used. The solid electrolytic capacitor can be thus produced.

Hereinafter, an example of the solid electrolytic capacitor according to the present disclosure will be specifically described with reference to the drawings. The above-described constituent elements can be applied to the constituent elements of the capacitor of the example described below. The capacitor of the example described below can be changed based on the above description. A matter described below may be applied to the exemplary embodiment described above. In the exemplary embodiments to be described below, constituent elements that are not essential to the solid electrolytic capacitor according to the present disclosure may be omitted.

The configuration of the solid electrolytic capacitor of the second exemplary embodiment will be described below with reference to the drawings, but the description of the same configuration as the configuration described in the first exemplary embodiment will be omitted. A plurality of recesses are formed on a surface of the buried part of the solid electrolytic capacitor according to the present exemplary embodiment at intervals. In the second embodiment, an example in which a plurality of recesses 201c are formed on both first surface 201a and second surface 201b will be described. Recess 201c is formed on both first surface 201a of anode lead frame 210 and first surface 201a of cathode lead frame 220.

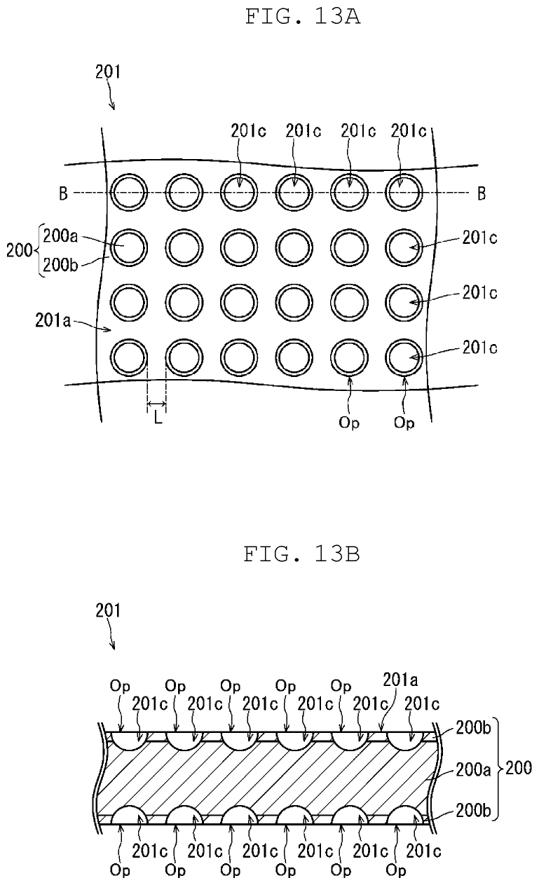

FIGS. 13A and 13B illustrate an example of arrangement of recesses 201c in buried part 201 (first buried part 211 and second buried part 221). FIG. 13A is a view of buried part 201 as viewed from upper surface 100t side. A section taken along line B-B in FIG. 13A is illustrated in FIG. 13B. In the example illustrated in FIG. 13A, the plurality of recesses 201c are disposed in a matrix at regular intervals L. In the example illustrated in FIGS. 13A and 13B, the arrangement of recesses 201c on one surface of buried part 201 is the same as the arrangement of recesses 201c on the other surface. The arrangement of the plurality of recesses 201c is not limited to the arrangement illustrated in FIGS. 13A and 13B, and may be another arrangement. In FIG. 13B, the sectional shape of recess 201c is schematically a hemispherical shape, but the sectional shape of recess 201c does not have to be a hemispherical shape.

As illustrated in FIGS. 13A and 13B, lead frame 200 (anode lead frame 210 and cathode lead frame 220) includes base material 200a and plating layer 200b formed on both surfaces of base material 200a. Planting layer 200b is formed on a surface of buried part 201 and a surface of exposed part 202 (surfaces of terminal part 212a and terminal part 222a). In solid electrolytic capacitor 100 according to the second exemplary embodiment, the plating layer formed on the surface of buried part 201 and the plating layer formed on the surface of exposed part 202 are connected without being divided.

Recesses 201c are formed on both surfaces of the buried part 201 of the lead frame 200. Planting layer 200b at the portion of recess 201c is removed. Planting layer 200b is present (remains) on the surface between the plurality of recesses 201c, the surface being first surface 201a of buried part 201. Base material 200a is exposed at the bottom of recess 201c. That is, recess 201c is formed in such a manner as to reach base material 200a and cut a part of base material 200a. In the example illustrated in FIGS. 2A and 2B, the shape of opening Op of recess 201c is a circular shape.

As described above, forming recess 201c can suppress deterioration (for example, an increase in ESR) of capacitor element 110. Thus, the reliability of the electrolytic capacitor 100 can be improved. In addition, the resistance between conductive adhesive layer 130 and cathode lead frame 220 can be reduced by forming recess 201c on a surface of second buried part 221 of cathode lead frame 220, the surface being in contact with conductive adhesive layer 130. As a result, characteristics of electrolytic capacitor 100 can be improved.

### Third Exemplary Embodiment

Hereinafter, a configuration of a third embodiment will be described, but the description of the same configuration as that of the first exemplary embodiment may be omitted.

### (Solid Electrolytic Capacitor)

A solid electrolytic capacitor according to the present exemplary embodiment includes: a capacitor element including an anode part and a cathode part; an anode lead frame electrically connected to the anode part; a cathode lead frame electrically connected to the cathode part via a conductive adhesive layer including conductive particles; and an exterior body covering the capacitor element. The anode lead frame includes a first buried part that is a part of the anode lead frame and is buried in the exterior body, and the cathode lead frame includes a second buried part that is a part of the cathode lead frame and is buried in the exterior body.

The buried part (first buried part, second buried part) includes a first surface in contact with the exterior body, and the second buried part includes a second surface in contact with the conductive adhesive layer. A plurality of first recesses are formed on the first surface. The exterior body includes a resin and an insulating filler. Average diameter D1 of the openings of the plurality of first recesses and average particle diameter P1 of the insulating filler satisfy 0<P1/D1<1.

In other words, a plurality of recesses are formed on a surface of the buried part. Hereinafter, the recesses may be referred to as “recesses (C)”. The plurality of recesses (C) include the plurality of first recesses formed on the first surface in contact with the exterior body. The first recess may be formed only in the first buried part, may be formed only in the second buried part, or may be formed in both of the first buried part and the second buried part. Recess (C) may be formed on both main surfaces of the lead frame, or may be formed only on one main surface of the lead frame.

Oxygen and the like (oxygen, moisture, and the like) easily reach the electrolyte layer through the interface between the buried part and the exterior body. In the capacitor of the present exemplary embodiment, a plurality of recesses (C) are formed on a surface of the buried part. This causes a penetration path of oxygen and the like through the interface between the buried part and the exterior body to be long, and thus oxygen and the like hardly reach the electrolyte layer. In addition, the surface area and the anchor effect of the buried part are increased by the plurality of recesses, and the adhesion between the buried part and the exterior body is improved. These can suppress deterioration of the electrolyte layer due to entry of oxygen and the like. As a result, deterioration of the capacitor element can be suppressed, and a solid electrolytic capacitor with high reliability can be obtained.

Further, in the solid electrolytic capacitor of the present exemplary embodiment, average diameter D1 and average particle diameter P1 of the insulating filler satisfy 0<P1/D1<1. This configuration allows the insulating filler to easily enter the first recess. The presence of the insulating filler having small thermal expansion in the first recess can suppress a decrease in adhesion between the lead frame and the exterior body due to a temperature change. As a result, deterioration of the electrolyte layer due to entry of oxygen or the like can be particularly suppressed.

Ratio P1/D1 between average particle diameter P1 and average diameter D1 may be more than 0, more than or equal to 0.1, more than or equal to 0.3, or more than or equal to 0.5. Ratio P1/D1 is less than 1, and may be less than or equal to 0.9, or less than or equal to 0.8. From the viewpoint of suppressing entry of oxygen or the like, average diameter D1 and average particle diameter P1 preferably satisfy 0.5≤P1/D1≤0.8.

Average diameter D1 may be more than or equal to 0.1 μm, more than or equal to 1 μm, more than or equal to 3 μm, more than or equal to 5 μm, more than or equal to 10 μm, or more than or equal to 20 μm, and may be less than or equal to 300 μm, less than or equal to 250 μm, less than or equal to 200 μm, less than or equal to 100 μm, or less than or equal to 50 μm. Average diameter D1 may be in a range from 0.1 μm to 300 μm, inclusive (for example, in a range from 5 μm to 100 μm, inclusive, in a range from 10 μm to 100 μm, inclusive, or in a range from 10 μm to 50 μm, inclusive).

An equivalent circle diameter can be used as the diameter of the opening of each recess. The equivalent circle diameter is obtained by the following method. First, the opening of the recess is photographed from above. Next, the obtained image is subjected to image processing to obtain the area of the opening. Next, the equivalent circle diameter is calculated from the obtained area. Average diameter D1 is obtained by calculating the diameter (equivalent circle diameter) of the opening for each of any selected 20 recesses and arithmetically averaging the obtained diameters. Average diameter D2 to be described later is also obtained in the same manner as average diameter D1.

Average particle diameter P1 is a median diameter (D50) at which a cumulative volume is 50% in a volume-based particle size distribution. The median diameter is determined using a laser diffraction/scattering type particle size distribution measuring apparatus. Average particle diameter P2 to be described later is also a median diameter (D50), and is determined in the same manner as average particle diameter P1.

A plurality of second recesses may be formed on the second surface in contact with the conductive adhesive layer. In other words, the plurality of recesses (C) may include a plurality of first recesses and a plurality of second recesses. The description of recess (C) can be applied to the first recess and the second recess unless otherwise specified.

Average diameter D2 of the openings of the plurality of second recesses and average particle diameter P2 of the conductive particles may satisfy 1.2≤ D2/P2. This configuration allows the conductive particles to easily enter the second recess. As a result, the resistance between the second buried part and the cathode part can be reduced. In addition, the presence of the conductive particles having small thermal expansion in the second recess can suppress a decrease in adhesion between the lead frame and the conductive adhesive layer due to a temperature change. As a result, deterioration of the electrolyte layer due to entry of oxygen or the like and an increase in internal resistance can be particularly suppressed.

Ratio D2/P2 between average diameter D2 and average particle diameter P2 may be less than 1.2, but is preferably more than or equal to 1.2, and may be more than or equal to 2. Ratio D2/P2 may be less than or equal to 20, or less than or equal to 15.

Average diameter D2 may be more than or equal to 5 μm, more than or equal to 10 μm, or more than or equal to 20 μm, and may be less than or equal to 500 μm, less than or equal to 400 μm, less than or equal to 300 μm, or less than or equal to 100 μm. Average diameter D2 may be in a range from 5 μm to 500 μm, inclusive (for example, in a range from 5 μm to 100 μm, inclusive).

Average diameter D2 may be larger than average diameter D1. Alternatively, average diameter D2 may be equal to or smaller than average diameter D1.

In the solid electrolytic capacitor of the present exemplary embodiment, average value Dmin(1) of the shortest diameters of the openings of the plurality of first recesses and average particle diameter P1 may satisfy a predetermined relationship. Specifically, ratio P1/Dmin(1) may satisfy the above relationship satisfied by ratio P1/D1. In the solid electrolytic capacitor of the present exemplary embodiment, average value Dmin(2) of the shortest diameters of the openings of the plurality of second recesses and average particle diameter P2 may satisfy a predetermined relationship. Specifically, ratio Dmin(2)/P2 may satisfy the above relationship satisfied by ratio D2/P2. The shortest diameter of the opening of a recess is the shortest diameter among diameters passing through the center of gravity of the opening of the recess. The shortest diameter can be determined as follows. First, an image of the openings of recesses is acquired by photographing a plurality of recesses from above. The center of gravity and the shortest diameter of the opening can be obtained by image analysis of the image. The average of the shortest diameters of the openings is obtained by obtaining the shortest diameter for each of 20 openings freely selected in the image and arithmetically averaging the obtained 20 shortest diameters.

In another aspect, the present disclosure provides another solid electrolytic capacitor. In the other solid electrolytic capacitor, whether ratio P1/D1 satisfies the above relationship is not limited, but ratio P1/Dmin(1) satisfies the above relationship satisfied by ratio P1/D1. In the other solid electrolytic capacitor, ratio Dmin(2)/P2 may satisfy the above relationship satisfied by ratio D2/P2. The other solid electrolytic capacitor is the same as the solid electrolytic capacitor according to the present exemplary embodiment except for these relationships, and thus overlapping description is omitted.

Recesses (C) can be formed by irradiating the lead frame with laser light (for example, pulsed laser light). Each of the plurality of first recesses and the plurality of second recesses can be formed by irradiation with laser light. As compared with the case of roughening the surface by sandblasting, etching, or the like, the case of forming recesses (C) by irradiation with laser light has the following advantages. Firstly, since variations in the shape and size of recesses (C) can be reduced, adhesion (airtightness) between the lead frame and the exterior body can be stably secured. Secondly, since the size of recesses (C) can be controlled according to the size of the insulating filler in the exterior body and the size of the conductive particles in the conductive adhesive layer, the adhesion (airtightness) can be further enhanced. Thirdly, since the size, shape, and arrangement pattern of recesses (C) can be changed depending on the position, the adhesion (airtightness) can be further enhanced.

Forming recesses (C) with laser light makes it possible to form the recesses having a uniform size and shape at desired positions. For example, it is also possible to control the diameter of the opening of the first recess to be in a range from 50% to 150%, inclusive, of average diameter D1. In the same manner, it is also possible to control the diameter of the opening of the second recess to be in a range from 50% to 150%, inclusive, of average diameter D2.

The depth of the plurality of recesses (C) may be more than or equal to 0.5 μm, more than or equal to 2 μm, or more than or equal to 10 μm, and may be less than or equal to 100 μm, less than or equal to 50 μm, or less than or equal to 30 μm. For example, the depths of recesses (C) may be from 2 μm to 50 μm, inclusive. The depths of recesses (C) can be changed by the output of laser light to be emitted to form recesses (C).

The plurality of recesses (C) may include a recess having a circular opening, may include a recess having a non-circular opening, or may include both. Examples of the recess having a non-circular opening include a recess obtained by forming a plurality of recesses each having a circular opening in such a manner that they partially overlap each other. Examples of the non-circular shape include a shape in which only a small portion of two adjacent circles overlap and a shape in which most of two adjacent circles overlap. Examples of the non-circular shape also include the shape of a locus when the circle is shifted. Examples of the non-circular shape include an elliptical shape, an elongated round shape, and an oval shape. The plurality of recesses (C) may include at least one recess having a groove shape.

The plurality of recesses (C) may be formed in the entire lead frame. Alternatively, the plurality of recesses (C) may be formed only on the surface of the buried part without being formed on the exposed part exposed from the exterior body. The plurality of recesses (C) may be formed only in a part of the buried part. The proportion (Sc/Sa) of area Sc occupied by the opening of recess (C) in apparent area Sa of the surface of the buried part may be more than or equal to 5%, more than or equal to 10%, more than or equal to 20%, more than or equal to 30%, and may be less than or equal to 90%, less than or equal to 80%, less than or equal to 70%, less than or equal to 60%, 50%, less than or equal to 40%, less than or equal to 30%, or less than or equal to 20%. The apparent area of the surface of the buried part is an area when it is assumed that the surface is a flat surface with no recesses (C), and can be calculated from the outer shape of the buried part.

The proportion (Sc1/Sa1) of area Sc1 occupied by the openings of the first recesses formed in the first buried part in apparent area Sa1 of the surface of the first buried part may fall within the range exemplified for the proportion (Sc/Sa). The proportion (Sc2/Sa2) of area Sc2 occupied by the openings of recesses (C) formed in the second buried part in apparent area Sa2 of the surface of the second buried part may fall within the range exemplified for the proportion (Sc/Sa). The proportion (Sc/Sa), the proportion (Sc1/Sa1), and the proportion (Sc2/Sa2) may be the same or different.

### Example of Configuration of Solid Electrolytic Capacitor

Examples of configurations and constituent elements of the solid electrolytic capacitor according to the present exemplary embodiment will be described below, but description of the same configurations as those described in the first exemplary embodiment will be omitted. (Anode lead frame and cathode lead frame)

As described above, the recesses (C) are formed in the lead frames. The anode lead frame is electrically connected to the anode part. The anode lead frame includes a first buried part buried in the exterior body and an exposed part exposed from the exterior body. At least a part of the exposed part functions as a terminal part. The terminal part is a part where soldering or the like is performed. The first buried part and the anode part can be connected by welding or the like.

The cathode lead frame is electrically connected to the cathode part. The cathode lead frame includes a second buried part buried in the exterior body and an exposed part exposed from the exterior body. At least a part of the exposed part functions as a terminal part. The terminal part is a part where soldering or the like is performed.

The lead frame (anode lead frame and cathode lead frame) is made of metal (copper, copper alloy, and the like). The lead frame before recess (C) is formed may be formed by processing a metal sheet (including a metal plate and a metal foil) made of metal (copper, copper alloy, and the like) by a known metal processing method. The thickness of the lead frame is not particularly limited, and may be in a range from 25 μm to 200 μm, inclusive (for example, in a range from 25 μm to 100 μm, inclusive).

The lead frame may include a plating layer formed on its surface. In this case, the lead frame includes a base material made of metal (copper, copper alloy, and the like) and a plating layer formed on the base material. The plating layer is formed of a metal (including an alloy) such as nickel, gold, palladium, tin, or copper, and may include a nickel layer, a gold layer, a palladium layer, a tin layer, a copper layer, or the like. For example, a plating layer may be formed on the lead frame in the order of a nickel layer, a gold layer, and a palladium layer.

### (Conductive Adhesive Layer)

The conductive adhesive layer includes conductive particles. Examples of the conductive particles include metal particles (for example, silver particles). The conductive adhesive layer can be formed using a metal paste (for example, a silver paste) containing metal particles and a resin.

### (Exterior Body)

The exterior body is disposed around the capacitor element so that the capacitor element is not exposed on the surface of the electrolytic capacitor. Further, the exterior body is disposed in such a manner as to cover the buried part of the anode lead frame and the buried part of the cathode lead frame.

The exterior body can be formed of a resin composition including an insulating resin and an insulating filler (for example, an inorganic filler). The resin composition may include a curing agent, a polymerization initiator, a catalyst, and the like in addition to the insulating resin and the insulating filler. Examples of the insulating resin include insulating thermosetting resin and insulating thermoplastic resin. Specific examples of the insulating resin include epoxy resin, phenol resin, urea resin, polyimide, polyamide-imide, polyurethane, diallyl phthalate, unsaturated polyester, polyphenylene sulfide (PPS), and polybutylene terephthalate (PBT).

Examples of the insulating filler include insulating particles and insulating fibers. Examples of the insulating material forming the insulating filler include insulating compounds (e.g., oxides) such as silica and alumina, glass, and mineral materials (e.g., talc, mica, or clay). The insulating filler contained in the exterior body may be one kind or two or more kinds.

The content of the insulating filler in the exterior body is not particularly limited, and may be in a range from 30 mass % to 95 mass %, inclusive (for example, in a range from 50 mass % to 90 mass %, inclusive).

### (Method for Producing Solid Electrolytic Capacitor)

A production method of the present exemplary embodiment for producing a solid electrolytic capacitor will be described below by way of example, but the description of the same configuration as the configuration described in the first exemplary embodiment will be omitted. Production method (M) is a method for producing a solid electrolytic capacitor including a capacitor element including an anode part and a cathode part, an anode lead frame electrically connected to the anode part, and a cathode lead frame electrically connected to the cathode part. The anode lead frame includes a first buried part that is a part of the anode lead frame, and the cathode lead frame includes a second buried part that is a part of the cathode lead frame. The buried part includes a first surface that is a surface of the first and second buried parts, and a second surface that is a surface of the second buried part and is different from the first surface. Production method (M) includes step (i), step (ii), and step (iii) in this order. These steps will be described below.

Step (i) is a step of forming a plurality of recesses (C) on a surface of the buried part by irradiating the buried part with laser light a plurality of times. Step (i) includes a step of forming a plurality of first recesses on the first surface by irradiating the first surface of the buried part with a first laser light a plurality of times. Step (i) may include a step of forming a plurality of second recesses on the second surface by irradiating the second surface of the second buried part with a second laser light a plurality of times. The first recess and the second recess may be formed under the same condition using the same laser light. Alternatively, the first recess and the second recess may be formed under different conditions using different types of laser light. A plurality of recesses may be formed also on a surface of the exposed part by irradiating the exposed part other than the buried part with laser light.

The plurality of recesses (C) may all be formed under the same condition (for example, the same laser light). Alternatively, some of the plurality of recesses (C) may be formed under different conditions (for example, different laser light). In such a case, the recesses formed under different conditions may have different sizes or different shapes. A plurality of recesses may be formed on the surfaces of the buried part and the exposed part by irradiating not only the buried part but also the exposed part with laser light.

Recess (C) can be formed using a known laser processing device capable of forming a recess in metal. The laser light to be emitted is not particularly limited as long as recess (C) can be formed. The wavelength of the laser light may be less than or equal to 1100 nm, less than or equal to 700 nm (for example, less than or equal to 600 nm), or more than or equal to 300 nm (for example, more than or equal to 350 nm). Using laser light having a short wavelength makes it possible to suppress a temperature rise of the lead frames when recess (C) is formed. Suppressing a temperature rise of the lead frames makes it possible to suppress deterioration (for example, oxidation) of the surfaces of the lead frames. The wavelength of the laser light may be 1064 nm (near infrared laser), 532 nm (visible light laser), or 355 nm (ultraviolet laser). The plurality of recesses (C) may be recesses formed by irradiation with laser light having a wavelength of from 300 nm to 1100 nm, inclusive (for example, from 300 nm to 600 nm, inclusive).

The plurality of recesses (C) may be formed by scanning laser light. Alternatively, the formation may be performed by moving a laser processing machine or the lead frames.

The laser light may be pulse laser light or continuous wave laser light (CW laser light). The recess having a circular opening may be formed by irradiation with pulsed laser light. The recess having a non-circular opening may be formed by irradiating pulsed laser light a plurality of times in such a manner that a part of the irradiation parts overlaps. Alternatively, the recess having a non-circular opening may be formed by irradiation with CW laser light (continuous wave laser light).

A preferred example of the laser light for forming recess (C) is laser light having a wavelength of 355 nm. The light source of the laser light having a wavelength of 355 nm is not particularly limited, and a third harmonic such as a YVO₄ laser may be used.

The diameter and average diameter D1 of the first recesses and the diameter and average diameter D2 of the second recesses can be controlled by changing laser light irradiation conditions (for example, the output of the laser or the spot diameter of the laser light). For example, the spot diameter of the laser light may be increased to increase the diameter and the average diameter of the recesses.

In an example of step (i), first, a metal sheet including portions to be a plurality of lead frames is prepared. Next, a portion of the metal sheet where recess (C) is to be formed is irradiated with laser light to form recess (C). Before or after the laser light irradiation, an unnecessary portion of the metal sheet is removed by known metal processing. Next, a portion of the lead frame that needs to be bent is bent by known metal processing. The metal sheet thus processed is used in the next step (ii).

Before step (ii), a capacitor element is prepared. Step (ii) is a step of electrically connecting the first buried part to the anode part of the capacitor element and electrically connecting the second buried part to the cathode part of the capacitor element. These connection methods are not particularly limited, and known connection methods may be used. For example, the first buried part may be connected to the anode part by welding. In step (ii), the second surface of the second buried part may be electrically connected to the cathode part via the conductive adhesive layer including conductive particles. Specifically, the cathode part and the second surface may be connected using a metal paste. In this case, the conductive adhesive layer enters the second recess.

Step (iii) is a step of covering the buried part and the capacitor element with an exterior body. Step (iii) can be performed by a known method. Specifically, step (iii) can be performed by covering the buried part and the capacitor element with a resin composition to be an exterior body, and then curing the resin composition. At this time, the exterior body enters the first recess. As the exterior body, an exterior body containing a resin (insulating resin) and an insulating filler can be used. The solid electrolytic capacitor can be thus produced. The solid electrolytic capacitor can be thus produced.

As described above, average diameter D1 of the openings of the plurality of first recesses and average particle diameter P1 of the insulating filler satisfy the above-described relationship. In addition, average diameter D2 of the openings of the plurality of second recesses and average particle diameter P2 of the conductive particles preferably satisfy the above-described relationship. Average particle diameter P1 and average particle diameter P2 can be controlled by selecting the insulating filler and the conductive particles to be used.

Hereinafter, an example of the solid electrolytic capacitor according to the present disclosure will be specifically described with reference to the drawings. The above-described constituent elements can be applied to the constituent elements of the capacitor of the example described below. The capacitor of the example described below can be changed based on the above description. A matter described below may be applied to the exemplary embodiment described above. In the exemplary embodiments to be described below, constituent elements that are not essential to the solid electrolytic capacitor according to the present disclosure may be omitted.

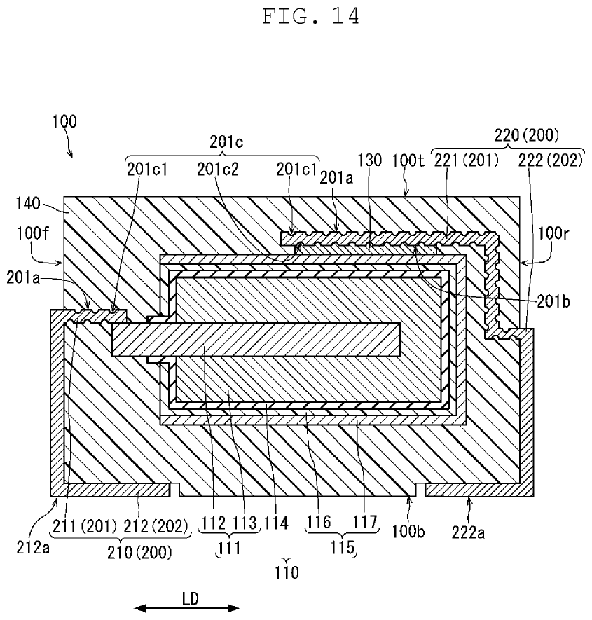

FIG. 14 schematically illustrates a sectional view of solid electrolytic capacitor 100 (hereinafter referred to as “electrolytic capacitor 100”) of the third exemplary embodiment. In the third embodiment, an example in which the anode part includes an anode body and an anode wire will be described.

Electrolytic capacitor 100 includes capacitor element 110, lead frame 200, conductive adhesive layer 130, and exterior body 140. Lead frame 200 includes anode lead frame 210 and cathode lead frame 220.

Capacitor element 110 includes anode part 111, dielectric layer 114, and cathode part 115. Anode part 111 includes anode body 113 and anode wire 112. Anode body 113 is a porous sintered body having a rectangular-parallelepiped shape, and dielectric layer 114 is formed on a surface of the anode body.

A part of anode wire 112 protrudes from one end surface of anode body 113 toward front surface 100f of electrolytic capacitor 100. The other part of anode wire 112 is buried in anode body 113. Anode wire 112 extends along longitudinal direction LD of anode body 113. Cathode part 115 includes electrolyte layer 116 disposed to cover at least a part of dielectric layer 114, and cathode layer 117 formed to cover at least a part of electrolyte layer 116.

Anode lead frame 210 includes first buried part 211 buried in exterior body 140 and exposed part 212 exposed from exterior body 140. Exposed part 212 includes terminal part 212a that functions as a terminal on the anode side. The surface on the side where terminal part 212a is present may be referred to as bottom surface 100b of electrolytic capacitor 100. The surface facing bottom surface 100b may be referred to as upper surface 100t of electrolytic capacitor 100. The surface facing front surface 100f may be referred to as rear surface 100r of electrolytic capacitor 100.

Cathode lead frame 220 includes second buried part 221 buried in exterior body 140 and exposed part 222 exposed from exterior body 140. Exposed part 222 includes terminal part 222a that functions as a terminal on the cathode side. Hereinafter, first buried part 211 and second buried part 221 may be collectively referred to as buried part 201, and exposed part 212 and exposed part 222 may be collectively referred to as exposed part 202. Lead frame 200 includes buried part 201 and exposed part 202.

The overall shape and arrangement of lead frame 200 and the connection positions between lead frame 200 and anode part 111 and cathode part 115 are not limited to the example illustrated in FIG. 14. For example, cathode lead frame 220 may be connected to cathode part 115 at a portion other than upper surface 100t (for example, a portion on bottom surface 100b side or a portion on rear surface 100r side).

Buried part 201 includes first surface 201a that is in contact with exterior body 140. Further, the buried part 201 includes second surface 201b that is a surface of second buried part 221 and is in contact with conductive adhesive layer 130. Second surface 201b is electrically connected to cathode part 115 (more specifically, cathode layer 117) by conductive adhesive layer 130.

A plurality of recesses are formed on a surface of the buried part of the solid electrolytic capacitor according to the present exemplary embodiment at intervals. The plurality of recesses 201c of electrolytic capacitor 100 include a plurality of first recesses 201c1 formed on first surface 201a and a plurality of second recesses 201c2 formed on second surface 201b. In the third exemplary embodiment, an example in which the plurality of recesses 201c includes first recess 201c1 and second recess 201c2 will be described. First recess 201c1 is formed on both first surface 201a of anode lead frame 210 and first surface 201a of cathode lead frame 220.

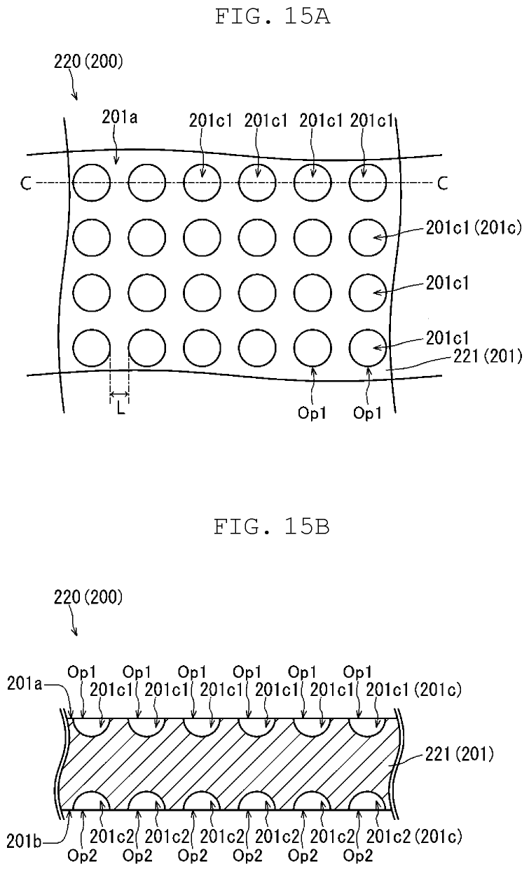

FIGS. 15A and 15B illustrate an example of arrangement of first recess 201c1 and second recess 201c2 in second buried part 221. FIG. 15A is a view of second buried part 221 as viewed from upper surface 100t side. A section taken along line C-C in FIG. 15A is illustrated in FIG. 15B. In the example illustrated in FIG. 15A, the plurality of first recesses 201c1 are disposed in a matrix at regular intervals L. In the example illustrated in FIGS. 15A and 15B, second recess 201c2 is also disposed in the same manner as first recess 201c1. However, the arrangement of the plurality of recesses 201c (recess 201c1 and recess 201c2) is not limited to the arrangement illustrated in FIGS. 15A and 15B and may be another arrangement. In FIG. 15B, the sectional shape of recess 201c is schematically a hemispherical shape, but the sectional shape of recess 201c does not have to be a hemispherical shape.

Exterior body 140 includes an insulating resin and an insulating filler (not illustrated). Conductive adhesive layer 130 includes conductive particles (not illustrated). Exterior body 140 enters the inside of first recess 201cl. Conductive adhesive layer 130 enters the inside of second recess 201c2. Average diameter D1 of openings Op1 of the plurality of first recesses 201c1 and average particle diameter P1 of the insulating filler satisfy the above-described relationship. Average diameter D2 of the openings Op2 of the plurality of second recesses 201c2 and average particle diameter P2 of the conductive particles preferably satisfy the above-described relationship.

As described above, forming recess 201c can suppress deterioration (for example, an increase in ESR) of capacitor element 110. Thus, the reliability of the electrolytic capacitor 100 can be improved. Forming second recess 201c2 can reduce the resistance between conductive adhesive layer 130 and cathode lead frame 220. As a result, characteristics of electrolytic capacitor 100 can be improved.

### INDUSTRIAL APPLICABILITY

The present disclosure is applicable to a solid electrolytic capacitor and a method for producing the solid electrolytic capacitor.

### REFERENCE MARKS IN THE DRAWINGS

100: solid electrolytic capacitor
110: capacitor element
111: anode part
112: anode wire
113: anode body
114: dielectric layer
115: cathode part
116: electrolyte layer
117: cathode layer
130: conductive adhesive layer
140: exterior body
200: lead frame
200a: base material
200b: plating layer
201: buried part
201a: first surface
201b: second surface
201c: recess
201cl: first recess
201c2: second recess
202, 212, 222: exposed part
210: anode lead frame
211: first buried part
212a, 222a: terminal part
220: cathode lead frame
221: second buried part
Op: opening
Op1: opening
Op2: opening
R: region

1. A solid electrolytic capacitor comprising:
a capacitor element including an anode part and a cathode part;
an anode lead frame electrically connected to the anode part;
a cathode lead frame electrically connected to the cathode part; and
an exterior body covering the capacitor element, wherein:
the anode lead frame includes a first buried part that is a part of the anode lead frame, the first buried part being buried in the exterior body,
the cathode lead frame includes a second buried part that is a part of the cathode lead frame, the second buried part being buried in the exterior body, and
a plurality of recesses are formed on a surface of at least one of the first buried part or the second buried part.

2. The solid electrolytic capacitor according to claim 1, wherein the plurality of recesses are formed on a surface of the first buried part and a surface of the second buried part.

3. The solid electrolytic capacitor according to claim 1, wherein the plurality of recesses include at least one first recess having a groove shape and a plurality of second recesses not each having a groove shape.

4. The solid electrolytic capacitor according to claim 3, wherein:
the at least one first recess has an opening, and
the opening satisfies 3<L1/W1,
where L1 denotes a length of the opening along a direction in which the opening is elonged, and W1 denotes a width of the opening.

5. The solid electrolytic capacitor according to claim 3, wherein the at least one first recess extends to intersect a longitudinal direction of the anode part.

6. The solid electrolytic capacitor according to claim 5, wherein:
at least one of the plurality of recesses is disposed in one of a plurality of band-shape regions that are located in the surface of the at least one of the first buried part of the second buried part, and
each of the plurality of band-shape regions extends along an intersecting direction intersecting the longitudinal direction of the anode part.

7. The solid electrolytic capacitor according to claim 6, wherein an interval between two adjacent recesses among the plurality of recesses in each of the plurality of band-shape regions is shorter than an interval between two adjacent band-shape regions among the plurality of band-shaped regions.

8. The solid electrolytic capacitor according to claim 6, wherein:
the at least one first recess and at least one of the plurality of second recesses are formed in each of the plurality of band-shape regions, and
a position in the intersecting direction where the at least one first recess is formed in one band-shape region among the plurality of band-shape regions is different from a position in the intersecting direction where the at least one first recess is formed in another band-shape region adjacent to the one band-shape region among the plurality of band-shape regions.

9. The solid electrolytic capacitor according to claim 1, wherein the plurality of recesses are recesses formed by irradiation with laser light.

10. The solid electrolytic capacitor according to claim 1, wherein a side surface of the at least one of the first buried part of the second buried part is processed to have irregularities.

11. The solid electrolytic capacitor according to claim 1, wherein:
at least one of the anode lead frame or the cathode lead frame includes a base material and a plating layer formed on a surface of the base material,
the plating layer is not present in each of the plurality of recesses, and
the plating layer is present in a region between the plurality of recesses on the surface of the at least one of the first buried part or the second buried part.

12. The solid electrolytic capacitor according to claim 11, wherein:
the plurality of recesses are formed on a surface of the first buried part and a surface of the second buried part, and
the region where the plurality of recesses are not formed in the surface of the at least one of the first buried part or the second buried part is covered with the plating layer.

13. The solid electrolytic capacitor according to claim 1, wherein a depth of each of the plurality of recesses is from 2 μm 50 μm, inclusive.

14. The solid electrolytic capacitor according to claim 11, wherein the base material is exposed from the plating layer at a bottom of each of the plurality of recesses.

15. The solid electrolytic capacitor according to claim 11, wherein the plurality of recesses include a recess having a circular opening.

16. The solid electrolytic capacitor according to claim 11, wherein a proportion (S1/S0) of an area S1 covered with the plating layer in the surface of the at least one of the first buried part or the second buried part in an area S0 of the surface of at least one of the first buried part or the second buried part is from 10% to 90%, inclusive.

17. A solid electrolytic capacitor comprising:
a capacitor element including an anode part and a cathode part;
an anode lead frame electrically connected to the anode part;
a cathode lead frame electrically connected to the cathode part via a conductive adhesive layer including conductive particles; and
an exterior body covering the capacitor element, wherein:
the anode lead frame includes a first buried part that is a part of the anode lead frame, the first buried part being buried in the exterior body,
the cathode lead frame includes a second buried part that is a part of the cathode lead frame, the second buried part being buried in the exterior body,
at least one of the first buried part or the second buried part includes a first surface that is in contact with the exterior body,
the second buried part includes a second surface that is in contact with the conductive adhesive layer,
a plurality of first recesses are formed on the first surface,
the exterior body includes a resin and an insulating filler, and
an average diameter D1 of openings of the plurality of first recesses and an average particle diameter P1 of the insulating filler satisfy 0<P1/D1<1.

18. The solid electrolytic capacitor according to claim 17, wherein the average diameter D1 and the average particle diameter P1 satisfy 0.5≤P1/D1≤0.8.

19. The solid electrolytic capacitor according to claim 17, wherein the average diameter D1 is in a range from 10 μm to 100 μm, inclusive.

20. The solid electrolytic capacitor according to claim 17, wherein a plurality of second recesses are formed on the second surface.

21. The solid electrolytic capacitor according to claim 20, wherein an average diameter D2 of openings of the plurality of second recesses and an average particle diameter P2 of the conductive particles satisfy 1.2≤D2/P2.

22. The solid electrolytic capacitor according to claim 21, wherein the average diameter D2 is in a range from 5 μm to 500 μm, inclusive.

23. The solid electrolytic capacitor according to claim 21, wherein the average diameter D2 is larger than the average diameter D1.

24. The solid electrolytic capacitor according to claim 20, wherein each of the plurality of first recesses and each of the plurality of second recesses are recesses formed by irradiation with laser light.

25. A method for producing a solid electrolytic capacitor, the solid electrolytic capacitor comprising a capacitor element including an anode part and a cathode part, an anode lead frame electrically connected to the anode part, and a cathode lead frame electrically connected to the cathode part, the anode lead frame including a first buried part that is a part of the anode lead frame, the cathode lead frame including a second buried part that is a part of the cathode lead frame, the method comprising:
a step (i) of forming a plurality of recesses on a surface of at least one of the first buried part or the second buried part by irradiating at least one of the first buried part or the second buried part with laser light a plurality of times;
a step (ii) of electrically connecting the first buried part to the anode part of the capacitor element and electrically connecting the second buried part to the cathode part of the capacitor element; and
a step (iii) of covering the first buried part, the second buried part, and the capacitor element with an exterior body, wherein:
the step (i) includes:
a step (i-a) of preparing at least one of the anode lead frame or the cathode lead frame including a base material and a plating layer formed on the base material, and
a step (i-b) of irradiating the plating layer on at least one of the first buried part or the second buried part with the laser light a plurality of times to form the plurality of recesses while the plating layer remains in a region between the plurality of recesses.

26. The method according to claim 25, wherein in the step (i-b), the plurality of recesses are formed so that the base material is exposed from the plating layer at a bottom of each of the plurality of recesses.

27. The method according to claim 25, wherein a wavelength of the laser light is in a range from 300 nm to 600 nm, inclusive.
